(19) United States
(12) Patent Application Publication
(10) Pub. No.: US 2023/0316167 A1
(43) Pub. Date: Oct. 5, 2023

(54) OPTIMIZATION DEVICE, OPTIMIZATION METHOD AND OPTIMIZATION PROGRAM

(71) Applicant: NEC Corporation, Minato-ku, Tokyo (JP)

(72) Inventors: Motoi Suzuki, Tokyo (JP); Hiroaki Inoue, Tokyo (JP); Takuya Araki, Tokyo (JP); Fumiyo Takano, Tokyo (JP); Yuki Kobayashi, Tokyo (JP); Hiroshi Chishima, Tokyo (JP); Akihiro Yatabe, Tokyo (JP); Takahiro Nishimura, Tokyo (JP)

(73) Assignee: NEC Corporation, Minato-ku, Tokyo (JP)

(21) Appl. No.: 18/016,900

(22) PCT Filed: Jul. 30, 2020
(86) PCT No.: PCT/JP2020/029356

§ 371 Date: Jan. 19, 2023

(51) Int. Cl. G06Q 10/047; G06N 10/60

(52) U.S. Cl. CPC G06Q 10/047; G06N 10/60

(57) ABSTRACT

An optimization device includes a determination unit which determines weights for a plurality of constraint conditions imposed on a combinatorial optimization problem, respectively, and a generation unit which generates an energy function for the combinatorial optimization problem using a constant that is a sum of a constant used in formulation of an energy to be optimized in the combinatorial optimization problem and a sum over the plurality of constraint conditions of a constant used in formulation of an energy of one constraint condition multiplied by a weight determined for the one constraint condition.

### TECHNICAL FIELD

The present invention relates to an optimization device, an optimization method, and an optimization program.

### BACKGROUND ART

The practical application of quantum annealing machines has triggered renewed interest in a study on combinatorial optimization problems. Combinatorial optimization problems are problems of finding optimal combinations. Examples of combinatorial optimization problems that represent real-world problems include the traveling salesman problem, the knapsack problem, the shift optimization problem, and the delivery planning problem.

The shift optimization problem, for example, is the problem of constructing the shifts of six employees over a 14-day period in such a way that the various constraint conditions imposed on them are satisfied. The imposed constraint conditions are: “No one employee is allowed to work four consecutive days or to take four consecutive holidays,” “The number of employees working in a day must be between three and four,” “Reflect each employee's vacation request,” and “Ensure that the number of days worked by all employees is not biased,” etc.

FIG. 8 is an explanatory diagram showing an example of a solution to the shift optimization problem. FIG. 8 shows the shifts of six employees A-F over a 14-day period obtained by solving the shift optimization problem. Specifically, the “O” and” X “shown in FIG. 8 represent “attendance” and “vacation,” respectively.

The above-described combinatorial optimization problem is described, for example, in Ising model form. The Ising model is a statistical mechanical model that represents the behavior of a magnetic material by its individual spins. In the Ising model, the orientations of each spin are represented by “1” or “−1”. The Ising model can formulate many combinatorial optimization problems.

When the combinatorial optimization problem is described in Ising model form, the equation representing the energy in the combinatorial optimization problem is first generated. Then, the equation representing the energy in the combinatorial optimization problem is converted to the energy function in the Ising model. The method of conversion to the energy function in the Ising model is well known. The energy function in the Ising model is represented as in the following Equation (1).

[Math. 1]

H_{ising}=ΣᵢⱼJᵢⱼsᵢsⱼ+Σᵢhᵢsᵢ Equation (1)

Both i and j in Equation (1) are variables representing spins. Also, sᵢ is a variable representing the orientation of spin i, and sⱼ is a variable representing the orientation of spin j in Equation (1). In other words, sᵢ and sⱼ are variables that are either “1” or “−1”.

Also, hᵢ in Equation (1) is a constant corresponding to spin i. For each possible value of i, hᵢ is determined as a constant. J_{Ij} in Equation (1) is a constant corresponding to the combination of spin i and spin j. For each possible combination of values of i and j, J_{Ij} is determined as a constant.

The Ising model in the case of total coupling can be represented, for example, by a complete graph. FIG. 9 is an explanatory diagram showing an example of a complete graph when the number of spins is seven.

The white arrows shown in FIG. 9 represent spins. Upward pointing white arrows represent spins where the value of the variable is “1”. The downward pointing white arrows represent spins where the value of the variable is “−1”.

Each edge connecting the white arrows represents a combination between spins. Each edge is assigned the value of J_{Ij} corresponding to the combination of spins, respectively.

Instead of the energy function in the Ising model, a QUBO (Quadratic Unconstrained Binary Optimization) energy function may be used. QUBO is a model that represents the orientations of each spin by “1” or “0”.

That is, the equation representing the energy in a combinatorial optimization problem can be converted to an energy function in QUBO. This conversion method is well known. Hereafter, a combinatorial optimization problem is said to be described in QUBO form when the equation representing the energy in the combinatorial optimization problem is represented by an energy function in QUBO.

The energy function in the Ising model and the energy function in QUBO are mutually convertible. The energy function in QUBO is represented as in the following Equation (2).

[Math. 2]

H_{QUBO}=ΣᵢⱼQᵢⱼxᵢxⱼ(x=(s+1)/2) Equation (2)

Both i and j in Equation (2) are variables representing spins. Also, xᵢ in Equation (2) is a variable representing the orientation of spin i, and xⱼ is a variable representing the orientation of spin j. Also, Qᵢⱼ in Equation (2) is a constant corresponding to the combination of spin i and spin j. For each possible combination of values of i and j, Qᵢⱼ is determined as a constant.

Given the energy function shown in Equation (1), the optimal individual spin orientation (1 or −1) is found when the combinatorial optimization problem is solved. Given the energy function shown in Equation (2), the optimal individual spin orientation (1 or 0) is found when the combinatorial optimization problem is solved. The optimal individual spin orientations found represent the solution to the combinatorial optimization problem.

For example, many combinatorial optimization problems can be attributed to minimization problems which are the problems of finding a combination that minimizes an arbitrary objective function (minimization target) under given constraint conditions. When the combinatorial optimization problem is a minimization problem, the optimal individual spin orientation is the orientation of the individual spins such that the energy indicated by the energy function is as small as possible.

As described above, the development of quantum computers capable of solving combinatorial optimization problems described in Ising model form at high speed has led to a growing interest in a study applying combinatorial optimization techniques. Quantum computers that use quantum mechanics are sometimes referred to as “real quantum”.

The constraint conditions are, for example, conditions that specify combinations of multiple spin orientations that are not allowed as solutions to the minimization problem. In the penalty method, if the solution to the minimization problem violates the constraint conditions, the constraint term, which is the term that results in higher energy, is added to the objective function.

Patent literature (PTL) 1 describes an optimization device that can reduce the computation time for combinatorial optimization problems with one-hot constraint, which is an example of the constraint condition.

For example, for the solution to the combinatorial optimization problem with the one-hot constraint, the penalty method determines the value of the energy function (evaluation function) as follows.

Solution to combinatorial optimization problem“00010000”:(value of energy function)=(objective function to be minimized)+0(·.·satisfies one-hot constraint)

Solution to combinatorial optimization problem“00010010”:(value of energy function)=(objective function to be minimized)+100(·.·violates one-hot constraint)

As an example, consider the energy formulation of the traveling salesman problem imposed the one-hot constraint. The traveling salesman problem in this example is the problem of determining the route, i.e., the order of cities to visit, when visiting the five cities A to E once each. In the traveling salesman problem, the optimal solution is the path with the smallest distance among the paths that visit all cities one at a time.

When the traveling salesman problem is described in Ising model form or QUBO form, 5×5=25 spins are used in the energy function. In this example, we consider the case where the traveling salesman problem is described in QUBO form.

FIG. 10 is an explanatory diagram showing an example of a solution to the traveling salesman problem. The “1” shown in FIG. 10 represents a salesman. In other words, the solution shown in FIG. 10 represents a route traveled by the salesman in the order of “city A→city D→city C→city B→city E→city A”.

Note that the constraint condition that the salesman can only visit one city at a time is imposed on the traveling salesman problem. For the solution shown in FIG. 10, the one-hot constraint is imposed on each city column and each order row, respectively.

The constant Qᵢⱼ in the QUBO energy function representing the energy in the traveling salesman problem of this example represents the interaction between spins. When the penalty method is used, the constant Qᵢⱼ is represented as the sum of Q_{distance}, representing the interaction based on the distance between cities, and Qₒₙₑₕₒₜ, representing the interaction based on the one-hot constraint, as follows. Note that “kp” represents the weight of the one-hot constraint.

Qᵢⱼ=Q_{distance}+kp×Qₒₙₑₕₒₜ

Citation List

### PATENT LITERATURE

PTL 1: Japanese Patent Application Laid-Open No. 2020-064536

### SUMMARY OF INVENTION

### Technical Problem

There is no single constraint condition imposed on a combinatorial optimization problem, but rather a wide variety of constraint conditions. For example, in the case of a shift optimization problem, it is considered that the following five types of constraint conditions are imposed.
The first constraint condition: “Do not assign the same employee to the same shift more than twice (principle constraint).”
The second constraint condition: “Prohibition of long consecutive working hours (legal constraint).”
The third constraint condition: “Reflect employees' high-priority leave requests.”
The forth constraint condition: “Assign at least one leader-rated employee per day.”
The fifth constraint condition: “Reflect employees' low-priority leave requests”/“Do not assign three employees, A, B, and C, to the same shift.”

In the above example, in solving the shift optimization problem, each constraint condition must be satisfied in the following order: the first constraint condition, the second constraint condition, . . . , and the fifth constraint condition. In other words, among the five constraint conditions, the first constraint condition must be satisfied the most. Also, among the five constraint conditions, the fifth constraint condition needs not be satisfied the most.

Hereafter, the constraint condition with a high priority, such as the first constraint condition above, that finding a solution to a combinatorial optimization problem would be meaningless if that constraint condition is not satisfied is called strong constraint condition. The constraint condition that has a lower priority than the strong constraint condition is called weak constraint condition.

The strength (priority) of each constraint condition depends on the user's objective of the optimization device. Therefore, if the user specifies the strength of each constraint condition respectively, and the optimization device solves the combinatorial optimization problem reflecting the specified strength, it is expected to find a solution to the combinatorial optimization problem according to the user's objective. However, in the optimization device described in PTL 1, the user cannot specify the strength of each constraint condition.

Therefore, it is an object of the present invention to provide an optimization device, an optimization method, and an optimization program that can reflect the user's priority for each constraint condition imposed on the combinatorial optimization problem in the combinatorial optimization problem.

### Solution to Problem

An optimization device according to the present invention is an optimization device includes a determination means which determines weights for a plurality of constraint conditions imposed on a combinatorial optimization problem, respectively, and a generation means which generates an energy function for the combinatorial optimization problem using a constant that is a sum of a constant used in formulation of an energy to be optimized in the combinatorial optimization problem and a sum over the plurality of constraint conditions of a constant used in formulation of an energy of one constraint condition multiplied by a weight determined for the one constraint condition.

An optimization device according to the present invention is an optimization device includes a solving means which executes a solving process that solves a combinatorial optimization problem on which a plurality of constraint conditions are imposed by a simulated annealing method, and an adjustment means which adjusts weights of each energy of the plurality of constraint conditions in an energy function for the combinatorial optimization problem based on priorities for each of the plurality of constraint conditions, using results of the solving process.

An optimization method according to the present invention is an optimization method includes determining weights for a plurality of constraint conditions imposed on a combinatorial optimization problem, respectively and generating an energy function for the combinatorial optimization problem using a constant that is a sum of a constant used in formulation of an energy to be optimized in the combinatorial optimization problem and a sum over the plurality of constraint conditions of a constant used in formulation of an energy of one constraint condition multiplied by a weight determined for the one constraint condition.

An optimization method according to the present invention is an optimization method includes executing a solving process that solves a combinatorial optimization problem on which a plurality of constraint conditions are imposed by a simulated annealing method, and adjusting weights of each energy of the plurality of constraint conditions in an energy function for the combinatorial optimization problem based on priorities for each of the plurality of constraint conditions, using results of the solving process.

A computer-readable recording medium recording an optimization program according to the present invention, when executed by a computer, stores the optimization program causing the computer to execute determining weights for a plurality of constraint conditions imposed on a combinatorial optimization problem, respectively, and generating an energy function for the combinatorial optimization problem using a constant that is a sum of a constant used in formulation of an energy to be optimized in the combinatorial optimization problem and a sum over the plurality of constraint conditions of a constant used in formulation of an energy of one constraint condition multiplied by a weight determined for the one constraint condition.

A computer-readable recording medium recording an optimization program according to the present invention, when executed by a computer, stores the optimization program causing the computer to execute executing a solving process that solves a combinatorial optimization problem on which a plurality of constraint conditions are imposed by a simulated annealing method, and adjusting weights of each energy of the plurality of constraint conditions in an energy function for the combinatorial optimization problem based on priorities for each of the plurality of constraint conditions, using results of the solving process.

### Advantageous Effects of Invention

According to this invention, it is possible to reflect the user's priority for each constraint condition imposed on the combinatorial optimization problem in the combinatorial optimization problem.

### BRIEF DESCRIPTION OF DRAWING

FIG. 1 is a block diagram showing an example of the configuration of an optimization device of the first example embodiment of the present invention.

FIG. 2 is a flowchart showing an operation of the combinatorial optimization problem solving process by the optimization device 100 of the first example embodiment.

FIG. 3 is a block diagram showing an example of the configuration of an optimization device of the second example embodiment of the present invention.

FIG. 4 is a flowchart showing an operation of the combinatorial optimization problem solving process by the optimization device 101 of the second example embodiment.

FIG. 5 is an explanatory diagram showing an example of a hardware configuration of an optimization device according to the present invention.

FIG. 6 is a block diagram showing an overview of an optimization device according to the present invention.

FIG. 7 is a block diagram showing an overview of another optimization device according to the present invention.

FIG. 8 is an explanatory diagram showing an example of a solution to the shift optimization problem.

FIG. 9 is an explanatory diagram showing an example of a complete graph when the number of spins is seven.

FIG. 10 is an explanatory diagram showing an example of a solution to the traveling salesman problem.

### DESCRIPTION OF EMBODIMENTS

### Example Embodiment 1

[Description of Configuration]

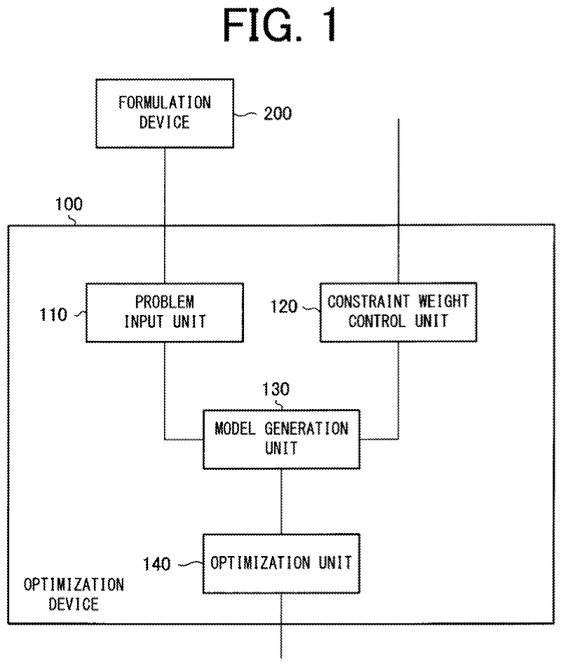

Hereinafter, a first example embodiment of the present invention will be described with reference to the drawings. FIG. 1 is a block diagram showing an example of the configuration of an optimization device of the first example embodiment of the present invention.

The optimization device 100 of this example embodiment is a device that converts a constrained optimization problem into an unconstrained optimization problem. Specifically, the optimization device 100 attributes a constrained optimization problem to an unconstrained optimization problem using a penalty method.

As shown in FIG. 1, the optimization device 100 includes a problem input unit 110, a constraint weight control unit 120, a model generation unit 130, and an optimization unit 140.

As shown in FIG. 1, the optimization device 100 is communicatively connected to the formulation device 200.

The formulation device 200 is a device that formulates the energy in the input combinatorial optimization problem as described above.

Consider the following example in which the formulation device 200 generates an energy function for a shift optimization problem in which the shifts of 30 employees over a 30-day period are made such that the imposed various constraint conditions are satisfied.

The constraint conditions imposed on the shift optimization problem in this example are: “No one employee is allowed to work five consecutive days,” “The number of employees working in a day must be between four and eight,” and “The total number of vacation days taken by any one employee must be at least eight.”

Other imposed constraint conditions are: “No one employee is allowed to take four consecutive holidays,” “Reflect each employee's vacation request,” “Assign at least one leader-rated employee per day,” and “Minimize the bias in the number of days worked by all employees.” The constraint condition “Reflect each employee's other wishes” may be imposed.

The formulation device 200 describes the input shift optimization problem in QUBO form. First, the formulation device 200 prepares N (>=900=30×30) variables xᵢ which are either “0” or “1”.

The formulation device 200 then formulates the energy of the optimization target (e.g., cost) in the shift optimization problem as shown in Equation (2). The formulation device 200 then formulates the energy of the constraint condition for each of the imposed constraint conditions, respectively, as follows.

[Math. 3]

ΣᵢⱼQᵢⱼ⁽¹⁾xᵢxⱼ,ΣᵢⱼQᵢⱼ⁽²⁾xᵢxⱼ, . . . ,ΣᵢⱼQᵢⱼ⁽⁷⁾xᵢxⱼ

That is, since there are seven constraint conditions imposed on the input shift optimization problem, the formulation device 200 formulates the energies of each of the seven constraint conditions, respectively.

The formulation device 200 inputs each constant Qᵢⱼ, Q⁽¹⁾ᵢⱼ-Q⁽⁷⁾ᵢⱼ used for each formulated energy to the problem input unit 110 of the optimization device 100. The user may input each constant directly into the optimization device 100.

Each constant Q⁽¹⁾ᵢⱼ-Q⁽⁷⁾ᵢⱼ corresponds to each of the constraint conditions imposed on the shift optimization problem, respectively. Each constant Qᵢⱼ, Q⁽¹⁾ᵢⱼ-Q⁽⁷⁾ᵢⱼ is input in matrix form. The problem input unit 110 inputs each of the input constants to the model generation unit 130.

The constraint weight control unit 120 has the function of controlling the weights wₖ (k=1-7) for each constraint condition, respectively. The constraint weight control unit 120 controls the weight wₖ so that the weight wₖ for the constraint condition that should be considered more is larger.

For example, the value of the weight wₖ may be input directly from the user to the constraint weight control unit 120. If the value is given explicitly by the user, the constraint weight control unit 120 may determine the given value to be the weight wₖ.

For example, the user may input the level to which each constraint condition falls to the constraint weight control unit 120 based on the levels of the pre-prepared constraint conditions. For example, the user may determine the level to which each constraint condition falls that is imposed on the shift optimization problem for which the formulation device 200 formulates energy, respectively, as follows.
“No one employee is allowed to work five consecutive days”: Level 8
“The number of employees working in a day must be four or more”: Level 7
“The number of employees working in a day must be eight or less”: Level 6
“The total number of vacation days taken by any one employee must be at least eight”: Level 5
“No one employee is allowed to take four consecutive holidays”: Level 4
“Reflect each employee's vacation request”: Level 3
“Assign at least one leader-rated employee per day”: Level 2
“Minimize the bias in the number of days worked by all employees”: Level 1

Note that the constraint conditions that fall to Level 8 are the strongest constraint conditions that finding a solution to the shift optimization problem would be meaningless if that constraint conditions are not satisfied. The constraint conditions that fall to Level 1 are the weakest constraint conditions. In other words, the level to which a constraint condition falls corresponds to the priority level of the constraint condition.

The user may input the priority level for the constraint condition to the constraint weight control unit 120, and the constraint weight control unit 120 may determine the level to which each constraint condition falls, based on the input priority level, respectively.

The constraint weight control unit 120 determines the weights wₖ for each constraint condition, respectively, based on the level to which each input constraint condition falls. For example, the constraint weight control unit 120 may determine the weights wₖ using a simple equation as shown below.

wₖ=(level)×(base value α)

The basic value α above is a positive constant. The basic value α may be a constant input by the user. The constraint weight control unit 120 inputs the determined weights wₖ to the model generation unit 130.

The model generation unit 130 has the function of generating an energy function for a combinatorial optimization problem that takes into account the priority of the imposed constraint conditions, using each constant input from the problem input unit 110 and each weight input from the constraint weight control unit 120.

Specifically, the model generation unit 130 calculates the constant Qₜₒₜₐₗ in the energy function as follows.

[Math. 4]

Qₜₒₜₐₗ=Qᵢⱼ+ΣₖwₖQᵢⱼ^{k} Equation (3)

Finally, the model generation unit 130 generates the QUBO energy function shown below.

[Math. 5]

H=ΣᵢⱼQₜₒₜₐₗxᵢxⱼ Equation (4)

In other words, the model generation unit 130 attributes the input shift optimization problem to the unconstrained optimization problem which is the problem that minimize the energy function shown in Equation (4) and constraint conditions are not imposed on. The model generation unit 130 inputs the energy function shown in Equation (4) to the optimization unit 140.

The optimization unit 140 has the function of solving the combinatorial optimization problem to be solved represented in the energy function input from the model generation unit 130.

The optimization unit 140 solves the combinatorial optimization problem by the simulated annealing method. The optimization unit 140 is realized, for example, by an existing simulated annealing machine.

As described above, the constraint weight control unit 120 of the optimization device 100 of this example embodiment determines the weights for a plurality of constraint conditions imposed on the combinatorial optimization problem, respectively.

The model generation unit 130 generates the energy function for the combinatorial optimization problem using a constant that is the sum of a constant used in the formulation of the energy to be optimized in the combinatorial optimization problem and the sum over the plurality of constraint conditions of the constant used in the formulation of the energy of one constraint condition multiplied by the weight determined for one constraint condition.

As described above, the constraint weight control unit 120 may determine the input plurality of weights to be weights for each of the plurality of constraint conditions.

As described above, the constraint weight control unit 120 may determine weights for each of the plurality of constraint conditions based on the input priorities for each of the plurality of constraint conditions. For example, the constraint weight control unit 120 may assign a rank (such as Levels 1-8 above) to each of the plurality of constraint conditions so that the higher the input priority, the lower the rank, and determine each value obtained by multiplying each assigned rank by a predetermined constant as weights for each of the plurality of constraint conditions.

[Description of Operation]

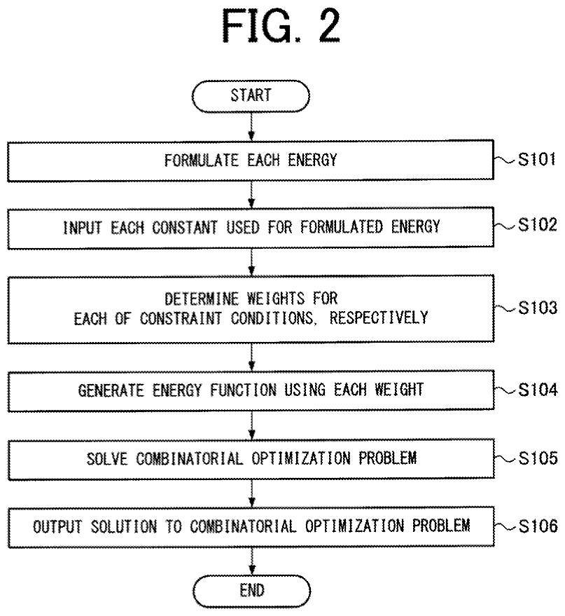

Hereinafter, the operation of the optimization device 100 of this example embodiment will be described with reference to FIG. 2. FIG. 2 is a flowchart showing an operation of the combinatorial optimization problem solving process by the optimization device 100 of the first example embodiment.

First, the formulation device 200 formulates the energy to be optimized in the input combinatorial optimization problem and the energies of each constraint condition imposed on the combinatorial optimization problem, respectively (step S101). The formulation device 200 inputs each constant used for each formulated energy to the problem input unit 110 of the optimization device 100.

Next, the problem input unit 110 inputs each of the input constants to the model generation unit 130 (step S102).

Next, the constraint weight control unit 120 determines weights for each of the constraint conditions imposed on the combinatorial optimization problem, respectively (step S103). The constraint weight control unit 120 inputs each determined weight to the model generation unit 130.

Next, the model generation unit 130 generates an energy function for the combinatorial optimization problem using each constant input from the problem input unit 110 and each weight input from the constraint weight control unit 120 (step S104). The model generation unit 130 inputs the generated energy function to the optimization unit 140.

Next, the optimization unit 140 solves the combinatorial optimization problem to be solved represented in the energy function input from the model generation unit 130 (step S105). Next, the optimization unit 140 outputs the solution to the combinatorial optimization problem calculated by solving (step S106). After outputting the solution to the combinatorial optimization problem, the optimization device 100 terminates the combinatorial optimization problem solving process.

[Description of Effect]

The model generation unit 130 of the optimization device 100 in this example embodiment generates an energy function for the combinatorial optimization problem using each weight in which user's objectives for each of the constraint conditions imposed on the combinatorial optimization problem are reflected.

For example, in general shift optimization problems, each weight for the plurality of constraint conditions is often all set to the same value. When each weight is all set to the same value, weak constraint conditions that do not need to be strongly considered in nature are strongly considered, which may degrade the accuracy of the solution.

When strong constraint conditions are weakly considered, the occurrence ratio of possible solutions that are solutions compatible with the shift optimization problem may reduce. For example, legal constraint conditions must be considered more strongly than constraint conditions that reflect employee preferences.

The constraint weight control unit 120 of the optimization device 100 in this example embodiment determines the weight for each constraint condition based on the priority which the user's objective and the contents of each constraint condition is reflected on, respectively. Thus, the optimization device 100 can obtain a solution that is compatible with the user's objective and more suitable than if the weights for each constraint condition were considered as a single weight.

### Example Embodiment 2

[Description of Configuration]

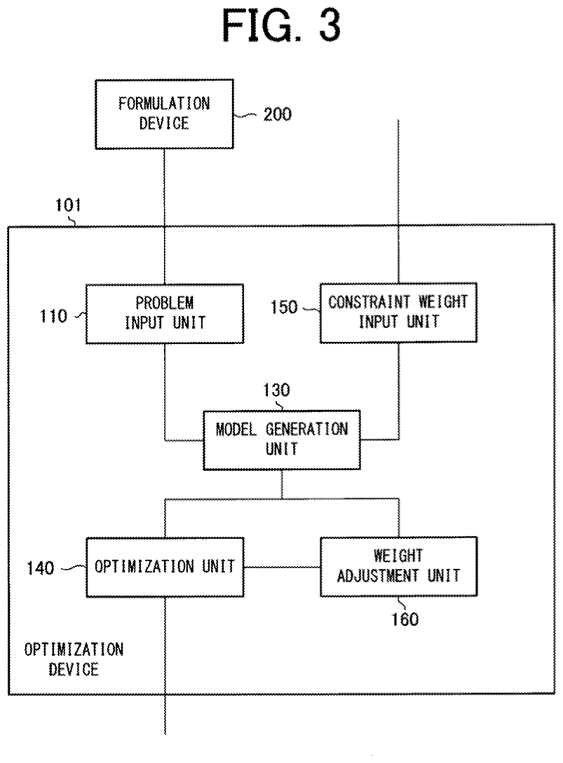

Next, a second example embodiment of the present invention will be described with reference to the drawings. FIG. 3 is a block diagram showing an example of the configuration of an optimization device of the second example embodiment of the present invention.

The optimization device 101 of this example embodiment is a device that solves combinatorial optimization problems while adjusting the weights wₖ based on the priority ranks of each constraint condition. In other words, the optimization device 101 dynamically determines the weights wₖ.

As shown in FIG. 3, the optimization device 101 includes a problem input unit 110, a model generation unit 130, an optimization unit 140, a constraint weight input unit 150, and a weight adjustment unit 160.

As shown in FIG. 3, the optimization device 101 is communicatively connected to the formulation device 200.

The problem input unit 110, the optimization unit 140, and the formulation device 200 of this example embodiment have the same functions as those in the first example embodiment, respectively.

The constraint weight input unit 150 of this example embodiment inputs the priority (strength) ranks of each constraint condition imposed on the combinatorial optimization problem to the model generation unit 130.

In addition, when generating the energy function for the combinatorial optimization problem using each constant input from the problem input unit 110, the model generation unit 130 of this example embodiment sets the all weights wₖ for each constraint condition to “1”. Therefore, the optimization unit 140 performs simulated annealing from a state in which the weights wₖ for each constraint condition are all “1”.

The weight adjustment unit 160 of this example embodiment has the function of dynamically adjusting the weights for the constraint conditions according to the input priority ranks of each constraint condition.

The weight adjustment unit 160 adjusts the weights so that the ranks of the violation degree of each constraint condition, arranged in descending order, match the priority ranks of each input constraint condition, arranged in ascending order. The violation degree of a constraint condition is defined, for example, as follows.

(violation degree)=(the number of solutions that do not satisfy the constraint condition)/(the number of all solutions searched)

For example, in the case of the traveling salesman problem, the optimization unit 140 goes through four combinations as “possible solution-violation solution-violation solution-possible solution,” until transiting a combination of multiple spin orientations which is a possible solution to a combination of multiple spin orientations which is a next possible solution.

Note that a violation solution is a solution that is not compatible with the traveling salesman problem. For example, a violation solution is a solution that represents a route in which some cities are visited 2 or more times or some cities are not visited at all. A possible solution is one that represents a route that all cities are visited once.

In other words, in order to calculate a possible solution, it is often necessary to go through several combinations of multiple spin orientations that are violation solutions. If the violation degree is set to “0,” it becomes difficult to solve the combinatorial optimization problem by simulated annealing.

The weight adjustment unit 160, for example, checks the violation degrees of each constraint condition each time the combination transits a predetermined number of times by simulated annealing by the optimization unit 140.

If the rank of the violation degree is lower than the confirmed priority rank of the constraint condition, the weight adjustment unit 160 shall slightly decrease the weight of the constraint condition. If the rank of the violation degree is higher than the confirmed priority rank of the constraint condition, the weight adjustment unit 160 shall slightly increase the weight of the constraint condition.

In other words, the weight adjustment unit 160 dynamically adjusts the weights of each constraint condition that is all “1” so that the ranks of the violation degree of each constraint condition match the priority ranks. In other words, the weight adjustment unit 160 adjusts the weights of each constraint condition so that it becomes an optimal weight that depends on the structure of the combinatorial optimization problem.

Finally, the weight adjustment unit 160 dynamically adjusts the weights for each constraint condition so that the constraint condition with the highest priority and the constraint condition with the lowest priority has the minimum and maximum violation degree, respectively.

The weight adjustment unit 160 may dynamically adjust only the above basic value α. The weight adjustment unit 160 may dynamically adjust the basis value α so that the ranks of the violation degree of each constraint condition match the priority ranks. For example, in the case of the traveling salesman problem, the basis value α should be “0.7” or higher.

If the lower and upper limits of the violation degrees of each constraint condition are given, the weight adjustment unit 160 may adjust the weights so that the violation degree falls between the given lower and upper limits.

The optimization unit 140 updates the energy function for the combinatorial optimization problem using each adjusted weight and performs simulated annealing again on the updated energy function.

As described above, the optimization unit 140 of the optimization device 101 in this example embodiment executes a solving process that solves a combinatorial optimization problem on which the plurality of constraint conditions are imposed by the simulated annealing method.

The weight adjustment unit 160 adjusts the weights of each energy of the plurality of constraint conditions in the energy function for the combinatorial optimization problem based on the priorities for each of the plurality of constraint conditions, using the results of the solving process. The optimization unit 140 then updates the energy function for the combinatorial optimization problem using the adjusted weights of each energy of the plurality of constraint conditions, and executes the solving process on the updated energy function.

As described above, the weight adjustment unit 160 may use the violation degree, which is the percentage of the number of solutions that do not satisfy the constraint conditions out of the number of solutions searched for in the solving process, as the result of the solving process.

For example, the weight adjustment unit 160 assigns priority ranks to each of the plurality of constraint conditions so that the higher the priority, the lower the rank. The weight adjustment unit 160 may assign ranks of the violation degree to each of the plurality of constraint conditions so that the higher the violation degree, the higher the rank, and adjust the weights of each energy of the plurality of constraint conditions so that each assigned priority rank matches each assigned rank of the violation degree, respectively.

[Description of Operation]

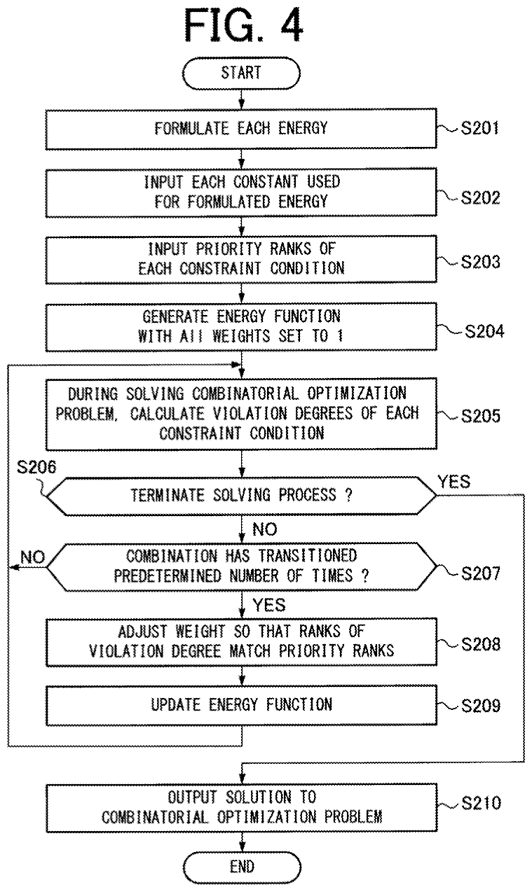

Hereinafter, the operation of the optimization device 101 of this example embodiment will be described with reference to FIG. 4. FIG. 4 is a flowchart showing an operation of the combinatorial optimization problem solving process by the optimization device 101 of the second example embodiment.

Each process of steps S201-S202 is the same as each process of steps S101-S102 shown in FIG. 2, respectively.

Next, the constraint weight input unit 150 inputs the priority ranks of each constraint condition imposed on the combinatorial optimization problem to the model generation unit 130 (step S203).

Next, the model generation unit 130 generates an energy function for the combinatorial optimization problem with the weights of each imposed constraint condition all set to “1”, using each constant input from the problem input unit 110 (step S204).

Next, the model generation unit 130 inputs the generated energy function to the optimization unit 140. The model generation unit 130 also inputs the priority ranks of each input constraint condition to the weight adjustment unit 160.

Next, the optimization unit 140 solves the combinatorial optimization problem to be solved represented in the energy function input from the model generation unit 130. Specifically, the optimization unit 140 updates the combination of multiple spin orientations in the input energy function.

During the solving, the optimization unit 140 calculates the violation degrees of each constraint condition using the searched solutions (possible and violation solutions) to the combinatorial optimization problem, respectively (step S205). For example, the optimization unit 140 may update the violation degrees of each constraint condition each time the combination of multiple spin orientations transitions, respectively. The optimization unit 140 stores the calculated violation degrees of each constraint condition.

Next, the optimization unit 140 determines whether to terminate the solving process for the combinatorial optimization problem (step S206). For example, if a solution with a predetermined accuracy or higher is obtained, or if the ranks of the violation degree of each constraint condition match the priority ranks, the optimization unit 140 terminates the solving process.

If it is determined that the solving process is not terminated (No in step S206), the optimization unit 140 checks whether the combination of multiple spin orientations has transitioned a predetermined number of times (step S207). If the combination of multiple spin orientations has not yet transitioned for the predetermined number of times (No in step S207), the optimization unit 140 returns to the process of step S205.

If the combination of multiple spin orientations transitions for the predetermined number of times (Yes in step S207), the optimization unit 140 input the violation degrees of each constraint condition stored to the weight adjustment unit 160.

Next, the weight adjustment unit 160 dynamically adjusts the weights of each constraint condition so that the ranks of the violation degree of each constraint condition match the priority ranks (step S208). The weight adjustment unit 160 inputs the adjusted weights of each constraint condition to the optimization unit 140.

Next, the optimization unit 140 updates the input energy function using the weights of each adjusted constraint condition (step S209). After updating the energy function, the optimization unit 140 returns to the process of step S205.

If it is determined that the solving process is terminated (Yes in step S206), the optimization unit 140 outputs the solution to the combinatorial optimization problem (step S210). After outputting the solution, the optimization device 101 terminates the combinatorial optimization problem solving process.

[Description of Effect]

The weight adjustment unit 160 of the optimization device 101 in this example embodiment dynamically adjusts the weights of each constraint condition so that the ranks of the violation degree of each constraint condition match the priority ranks. Since the weights of each constraint condition are dynamically adjusted using the violation degree based on the result of the solving process for the combinatorial optimization problem, the optimization device 101 can obtain a more appropriate solution to the combinatorial optimization problem.

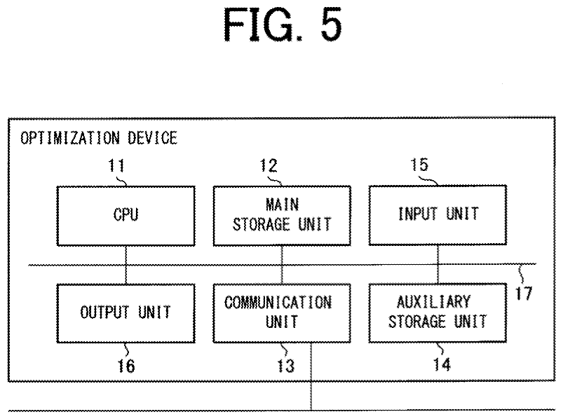

A specific example of a hardware configuration of the optimization device 100-101 according to each example embodiment will be described below. FIG. 5 is an explanatory diagram showing an example of a hardware configuration of an optimization device according to the present invention.

The optimization device shown in FIG. 5 includes a CPU (Central Processing Unit) 11, a main storage unit 12, a communication unit 13, and an auxiliary storage unit 14. The optimization device also includes an input unit 15 for the user to operate and an output unit 16 for presenting a processing result or a progress of the processing contents to the user.

The optimization device is realized by software, with the CPU 11 shown in FIG. 5 executing a program that provides a function that each component has.

Specifically, each function is realized by software as the CPU 11 loads the program stored in the auxiliary storage unit 14 into the main storage unit 12 and executes it to control the operation of the optimization device.

The optimization device shown in FIG. 5 may include a DSP (Digital Signal Processor) instead of the CPU 11. Alternatively, the optimization device shown in FIG. 5 may include both the CPU 11 and the DSP.

The main storage unit 12 is used as a work area for data and a temporary save area for data. The main storage unit 12 is, for example, RAM (Random Access Memory).

The communication unit 13 has a function of inputting and outputting data to and from peripheral devices through a wired network or a wireless network (information communication network).

The auxiliary storage unit 14 is a non-transitory tangible medium. Examples of non-transitory tangible media are, for example, a magnetic disk, an optical magnetic disk, a CD-ROM (Compact Disk Read Only Memory), a DVD-ROM (Digital Versatile Disk Read Only Memory), a semiconductor memory.

The input unit 15 has a function of inputting data and processing instructions. The input unit 15 is, for example, an input device such as a keyboard or a mouse.

The output unit 16 has a function to output data. The output unit 16 is, for example, a display device such as a liquid crystal display device, or a printing device such as a printer.

As shown in FIG. 5, in the optimization device, each component is connected to the system bus 17.

The auxiliary storage unit 14 stores programs for realizing the problem input unit 110, the constraint weight control unit 120, the model generation unit 130 and the optimization unit 140 in the optimization device 100 of the first example embodiment.

The optimization device 100 may be implemented with a circuit that contains hardware components inside such as an LSI (Large Scale Integration) that realize the functions shown in FIG. 1, for example.

The auxiliary storage unit 14 stores programs for realizing the problem input unit 110, the model generation unit 130, the optimization unit 140, the constraint weight input unit 150 and the weight adjustment unit 160 in the optimization device 101 of the second example embodiment.

The optimization device 101 may be implemented with a circuit that contains hardware components inside such as an LSI that realize the functions shown in FIG. 3, for example.

The optimization device 100-101 may be realized by hardware that does not include computer functions using elements such as a CPU. For example, some or all of the components may be realized by a general-purpose circuit (circuitry) or a dedicated circuit, a processor, or a combination of these. They may be configured by a single chip (for example, the LSI described above) or by multiple chips connected via a bus. Some or all of the components may be realized by a combination of the above-mentioned circuit, etc. and a program.

In the case where some or all of the components are realized by a plurality of information processing devices, circuits, or the like, the plurality of information processing devices, circuits, or the like may be centrally located or distributed. For example, the information processing devices, circuits, etc. may be realized as a client-server system, a cloud computing system, etc., each of which is connected via a communication network.

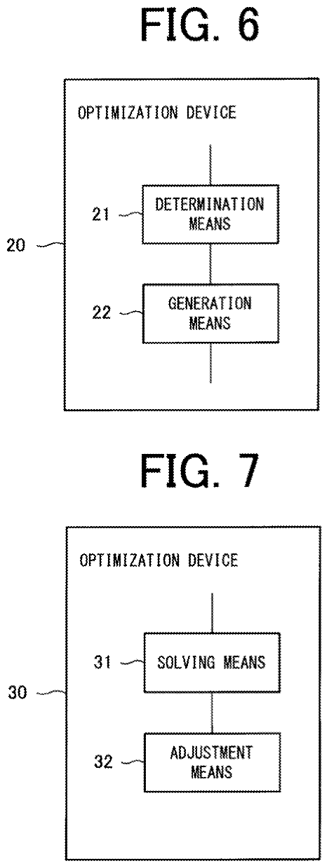

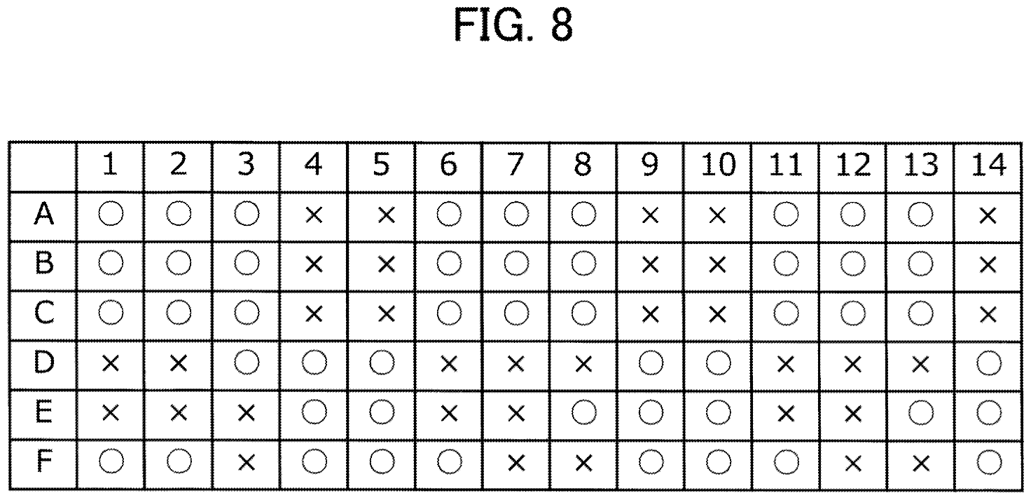

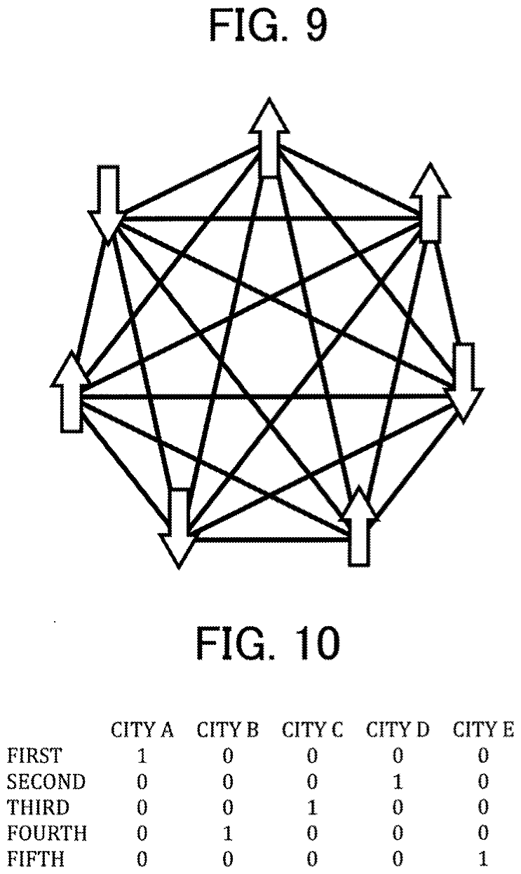

Next, an overview of the present invention will be explained. FIG. 6 is a block diagram showing an overview of an optimization device according to the present invention. The optimization device 20 according to the present invention includes a determination means 21 (for example, the constraint weight control unit 120) which determines weights for a plurality of constraint conditions imposed on a combinatorial optimization problem, respectively, and a generation means 22 (for example, the model generation unit 130) which generates an energy function for the combinatorial optimization problem using a constant that is a sum of a constant used in formulation of an energy to be optimized in the combinatorial optimization problem and a sum over the plurality of constraint conditions of a constant used in formulation of an energy of one constraint condition multiplied by a weight determined for the one constraint condition.

With such a configuration, the optimization device can reflect the user's priority for each constraint condition imposed on the combinatorial optimization problem in the combinatorial optimization problem.

The determination means 21 may determine an input plurality of weights to be weights for each of the plurality of constraint conditions.

With such a configuration, the optimization device can use values explicitly specified by the user as weights for the constraint conditions.

The determination means 21 may determine weights for each of the plurality of constraint conditions based on input priorities for each of the plurality of constraint conditions. For example, the determination means 21 may assign a rank to each of the plurality of constraint conditions so that the higher the input priority, the lower the rank, and determine each value obtained by multiplying each assigned rank by a predetermined constant as weights for each of the plurality of constraint conditions.

With such a configuration, the optimization device can determine weights based on the priority ranks of each constraint condition specified by the user.

FIG. 7 is a block diagram showing an overview of another optimization device according to the present invention. The optimization device 30 according to the present invention includes a solving means 31 (for example, the optimization unit 140) which executes a solving process that solves a combinatorial optimization problem on which a plurality of constraint conditions are imposed by a simulated annealing method, and an adjustment means 32 (for example, the weight adjustment unit 160) which adjusts weights of each energy of the plurality of constraint conditions in an energy function for the combinatorial optimization problem based on priorities for each of the plurality of constraint conditions, using results of the solving process.

The solving means 31 may update the energy function for the combinatorial optimization problem using the adjusted weights of each energy of the plurality of constraint conditions, and execute the solving process on the updated energy function.

With such a configuration, the optimization device can reflect the user's priority for each constraint condition imposed on the combinatorial optimization problem in the combinatorial optimization problem.

The adjustment means 32 may use a violation degree, which is a percentage of the number of solutions that do not satisfy the constraint conditions out of the number of solutions searched for in the solving process, as the result of the solving process. For example, the adjustment means 32 may assign priority ranks to each of the plurality of constraint conditions so that the higher the priority, the lower the rank, assign ranks of the violation degree to each of the plurality of constraint conditions so that the higher the violation degree, the higher the rank, and adjust the weights of each energy of the plurality of constraint conditions so that each assigned priority rank matches each assigned rank of the violation degree, respectively.

With such a configuration, the optimization device can obtain a more appropriate solution to the combinatorial optimization problem.

Some or all of the aforementioned example embodiment can be described as supplementary notes mentioned below, but are not limited to the following supplementary notes.

(Supplementary note 1) An optimization device comprising: a determination means which determines weights for a plurality of constraint conditions imposed on a combinatorial optimization problem, respectively; and a generation means which generates an energy function for the combinatorial optimization problem using a constant that is a sum of a constant used in formulation of an energy to be optimized in the combinatorial optimization problem and a sum over the plurality of constraint conditions of a constant used in formulation of an energy of one constraint condition multiplied by a weight determined for the one constraint condition.

(Supplementary note 2) The optimization device according to supplementary note 1, wherein the determination means determines an input plurality of weights to be weights for each of the plurality of constraint conditions.

(Supplementary note 3) The optimization device according to supplementary note 1, wherein the determination means determines weights for each of the plurality of constraint conditions based on input priorities for each of the plurality of constraint conditions.

(Supplementary note 4) The optimization device according to supplementary note 3, wherein the determination means: assigns a rank to each of the plurality of constraint conditions so that the higher the input priority, the lower the rank; and determines each value obtained by multiplying each assigned rank by a predetermined constant as weights for each of the plurality of constraint conditions.

(Supplementary note 5) An optimization device comprising: a solving means which executes a solving process that solves a combinatorial optimization problem on which a plurality of constraint conditions are imposed by a simulated annealing method; and an adjustment means which adjusts weights of each energy of the plurality of constraint conditions in an energy function for the combinatorial optimization problem based on priorities for each of the plurality of constraint conditions, using results of the solving process.

(Supplementary note 6) The optimization device according to supplementary note 5, wherein the solving means: updates the energy function for the combinatorial optimization problem using the adjusted weights of each energy of the plurality of constraint conditions; and executes the solving process on the updated energy function.

(Supplementary note 7) The optimization device according to supplementary note 5 or 6, wherein the adjustment means uses a violation degree, which is a percentage of the number of solutions that do not satisfy the constraint conditions out of the number of solutions searched for in the solving process, as the result of the solving process.

(Supplementary note 8) The optimization device according to supplementary note 7, wherein the adjustment means: assigns priority ranks to each of the plurality of constraint conditions so that the higher the priority, the lower the rank; assigns ranks of the violation degree to each of the plurality of constraint conditions so that the higher the violation degree, the higher the rank; and adjusts the weights of each energy of the plurality of constraint conditions so that each assigned priority rank matches each assigned rank of the violation degree, respectively.

(Supplementary note 9) An optimization method comprising: determining weights for a plurality of constraint conditions imposed on a combinatorial optimization problem, respectively; and generating an energy function for the combinatorial optimization problem using a constant that is a sum of a constant used in formulation of an energy to be optimized in the combinatorial optimization problem and a sum over the plurality of constraint conditions of a constant used in formulation of an energy of one constraint condition multiplied by a weight determined for the one constraint condition.

(Supplementary note 10) An optimization method comprising: executing a solving process that solves a combinatorial optimization problem on which a plurality of constraint conditions are imposed by a simulated annealing method; and adjusting weights of each energy of the plurality of constraint conditions in an energy function for the combinatorial optimization problem based on priorities for each of the plurality of constraint conditions, using results of the solving process.

(Supplementary note 11) A computer-readable recording medium recording an optimization program causing a computer to execute: determining weights for a plurality of constraint conditions imposed on a combinatorial optimization problem, respectively; and generating an energy function for the combinatorial optimization problem using a constant that is a sum of a constant used in formulation of an energy to be optimized in the combinatorial optimization problem and a sum over the plurality of constraint conditions of a constant used in formulation of an energy of one constraint condition multiplied by a weight determined for the one constraint condition.

(Supplementary note 12) A computer-readable recording medium recording an optimization program causing a computer to execute: executing a solving process that solves a combinatorial optimization problem on which a plurality of constraint conditions are imposed by a simulated annealing method; and adjusting weights of each energy of the plurality of constraint conditions in an energy function for the combinatorial optimization problem based on priorities for each of the plurality of constraint conditions, using results of the solving process.

(Supplementary note 13) An optimization program causing a computer to execute: a determination process of determining weights for a plurality of constraint conditions imposed on a combinatorial optimization problem, respectively; and a generation process of generating an energy function for the combinatorial optimization problem using a constant that is a sum of a constant used in formulation of an energy to be optimized in the combinatorial optimization problem and a sum over the plurality of constraint conditions of a constant used in formulation of an energy of one constraint condition multiplied by a weight determined for the one constraint condition.

(Supplementary note 14) An optimization program causing a computer to execute: a solving process of solving a combinatorial optimization problem on which a plurality of constraint conditions are imposed by a simulated annealing method; and an adjustment process of adjusting weights of each energy of the plurality of constraint conditions in an energy function for the combinatorial optimization problem based on priorities for each of the plurality of constraint conditions, using results of the solving process.

Although the invention of the present application has been described above with reference to example embodiments and examples, the present invention is not limited to the above example embodiments and examples. Various changes can be made to the configuration and details of the present invention that can be understood by those skilled in the art within the scope of the present invention.

### REFERENCE SIGNS LIST

11 CPU
12 Main storage unit
13 Communication unit
14 Auxiliary storage unit
15 Input unit
16 Output unit
17 System bus
20, 30, 100, 101 Optimization device
21 Determination means
22 Generation means
31 Solving means
32 Adjustment means
110 Problem input unit
120 Constraint weight control unit
130 Model generation unit
140 Optimization unit
150 Constraint weight input unit
160 Weight adjustment unit
200 Formulation device

What is claimed is:

1. (canceled)

2. (canceled)

3. (canceled)

4. (canceled)

5. An optimization device comprising:
a memory configured to store instructions; and
a processor configured to execute the instructions to:
execute a solving process that solves a combinatorial optimization problem on which a plurality of constraint conditions are imposed by a simulated annealing method; and
adjust weights of each energy of the plurality of constraint conditions in an energy function for the combinatorial optimization problem based on priorities for each of the plurality of constraint conditions, using results of the solving process.

6. The optimization device according to claim 5, wherein the processor is further configured to execute the instructions to:
updates the energy function for the combinatorial optimization problem using the adjusted weights of each energy of the plurality of constraint conditions; and
executes the solving process on the updated energy function.

7. The optimization device according to claim 5, wherein the processor is further configured to execute the instructions to:
uses a violation degree, which is a percentage of the number of solutions that do not satisfy the constraint conditions out of the number of solutions searched for in the solving process, as the result of the solving process.

8. The optimization device according to claim 7, wherein the processor is further configured to execute the instructions to:
assigns priority ranks to each of the plurality of constraint conditions so that the higher the priority, the lower the rank;
assigns ranks of the violation degree to each of the plurality of constraint conditions so that the higher the violation degree, the higher the rank; and
adjusts the weights of each energy of the plurality of constraint conditions so that each assigned priority rank matches each assigned rank of the violation degree, respectively.

9. (canceled)

10. An optimization method comprising:
executing a solving process that solves a combinatorial optimization problem on which a plurality of constraint conditions are imposed by a simulated annealing method; and
adjusting weights of each energy of the plurality of constraint conditions in an energy function for the combinatorial optimization problem based on priorities for each of the plurality of constraint conditions, using results of the solving process.

11. (canceled)

12. A computer-readable recording medium recording an optimization program causing a computer to execute:
executing a solving process that solves a combinatorial optimization problem on which a plurality of constraint conditions are imposed by a simulated annealing method; and
adjusting weights of each energy of the plurality of constraint conditions in an energy function for the combinatorial optimization problem based on priorities for each of the plurality of constraint conditions, using results of the solving process.
